(19) United States
(12) Patent Application Publication
(10) Pub. No.: US 2005/0063092 A1
(43) Pub. Date: Mar. 24, 2005

(54) Side mounted air plate and diverter for a data storage device

(76) Inventors: Mo Xu, Singapore (SG); KongBeng Terang Thia, Singapore (SG); ChorShan Cheng, Singapore (SG)

Correspondence Address: Jennifer M. Buenzow;Seagate Technology LLC, 1280 Disc Drive, Shakopee, MN, 55379, US

(21) Appl. No.: 10/668,513

(22) Filed: Sep. 22, 2003

(51) Int. Cl. G11B 33/14

(52) U.S. Cl. 360/97.02

(57) ABSTRACT

A method and combination for mitigating turbulent air flow across an actuator and a disc stack assembly of a data storage device. The combination includes a combination air plate and diverter with a retention member supporting an air plate/diverter member protruding through a diverter mounting aperture of a base deck. The base deck provides a diverter mounting surface confining the diverter mounting aperture and an attachment receptacle communicating with an attachment means to secure the retention member adjacent the diverter mounting surface. The method includes disposing the retention member adjacent the diverter mounting surface, press fitting an alignment pin supported by the retention member into an alignment receptacle of the base deck, securing the combination air plate and diverter to the base deck with an attachment means, and sealing an internal environment of the base deck from intrusion by an environment external to the base deck.

### FIELD OF THE INVENTION

The claimed invention relates to the field of data storage devices. More particularly, but not by way of limitation, this invention relates to a combination and method for controlling the aerodynamic excitation imparted to disc drive components by airstreams generated by spinning discs in a data storage device.

### BACKGROUND

One key component of many electronic systems is a device, such as a data storage device (DSD) to store data. One method in which DSDs store digital data is in magnetic form on a rotating storage disc. DSDs have an outer framework that includes, a base deck and top cover. The base deck is essentially a platform to which DSD components are secured, and is of a size and shape to engage the computer. The top cover cooperates with the base deck to form an internal sealed compartment for housing other components of the DSD.

A major challenge for mechanical designs of DSDs is to limit vibration of the disc stack assembly and the actuator assembly during active operating modes of the DSD. As increases in aerial density (a measure of an amount of information that can be stored on a unit of area of the magnetic disc) and disc rotational speed continues to escalate, reduction of vibration experienced by the disc stack assembly and the actuator assembly becomes increasingly more important.

Increasing aerial density is typically attained by increasing the total number of data tracks supported by the disc. Increasing the total number of data tracks supported by the disc frequently entails decreasing the physical width of each data track. As the width of each data track decreases and the number of data tracks supported by the disc surface increases, attaining and maintaining alignment between the head and a selected data track while seeking to the selected data track and while performing data exchange operation heightens a need for more precise control of the disc stack assembly and the actuator assembly.

With increases in disc rotational speed, vibration due to airflow generated by the rotation of the disc becomes a more dominant source of vibration for the disc stack assembly and the actuator assembly. The presence of vibration induced disturbances of the disc stack assembly and the actuator assembly disadvantageously increases the settle time for the heads to come on track following a seek operation, and increases the occurrence of off track errors during track following and data exchange operations. Increased settle times and increased occurrences of off track errors erode data throughput performance of the DSD and may lead to unrecoverable data, or to previously written data being inadvertently overwritten.

As such, challenges remain and a need persists for improvements in methods and apparatus to reduce vibrations experienced by the disc stack assembly and the actuator assembly during dynamic operations of a DSD.

### SUMMARY OF THE INVENTION

In accordance with preferred embodiments, a method and combination are provided for mitigating turbulent air flow across an actuator and a disc stack of a data storage device. The combination preferably includes a base deck that has a diverter mounting aperture, an attachment receptacle, and an alignment receptacle each confined by a diverter mounting surface.

In one embodiment of the present invention, the combination further preferably includes a combination air plate and diverter with a retention member supporting an air plate/diverter member that protrudes through the diverter mounting aperture of the base deck. The retention member further preferentially supports an alignment pin that engages the alignment receptacle, and a mounting aperture that receives an attachment means, which secures the retention member adjacent the diverter mounting surface through an interaction with the attachment receptacle.

In a further embodiment of the present invention, the method preferentially includes; disposing the retention member adjacent the diverter mounting surface, press fitting the alignment pin supported by the retention member into the alignment receptacle of the base deck, securing the combination air plate and diverter to the base deck with the attachment means, and sealing an internal environment of the base deck from intrusion by an environment external to the base deck with a seal.

These and various other features and advantages that characterize the claimed invention will be apparent upon reading the following detailed description and upon review of the associated drawings.

### BRIEF DESCRIPTION OF THE DRAWINGS

FIG. 1 is a partial cut-away top plan view of a data storage device (DSD) that incorporates a combination air plate and diverter for mitigating turbulent air flow across a disc stack assembly and an actuator assembly of the DSD.

FIG. 2 is a top perspective view of the combination air plate and diverter of the DSD of FIG. 1.

FIG. 3 is a top perspective view of the combination air plate and diverter in relation to a top perspective view of a base deck of the DSD of FIG. 1.

FIG. 4 is a top perspective view of the combination air plate and diverter secured to the base deck of FIG. 3, for clarity, the disc stack assembly is not shown.

FIG. 5 is a graphical representation of a position error signal of the DSD of FIG. 1 with and without the combination air plate and diverter of FIG. 2.

FIG. 6 is a flow chart of an assembly process for securing the combination air plate and diverter of FIG. 2 to the base deck of the DSD of FIG. 1.

### DETAILED DESCRIPTION

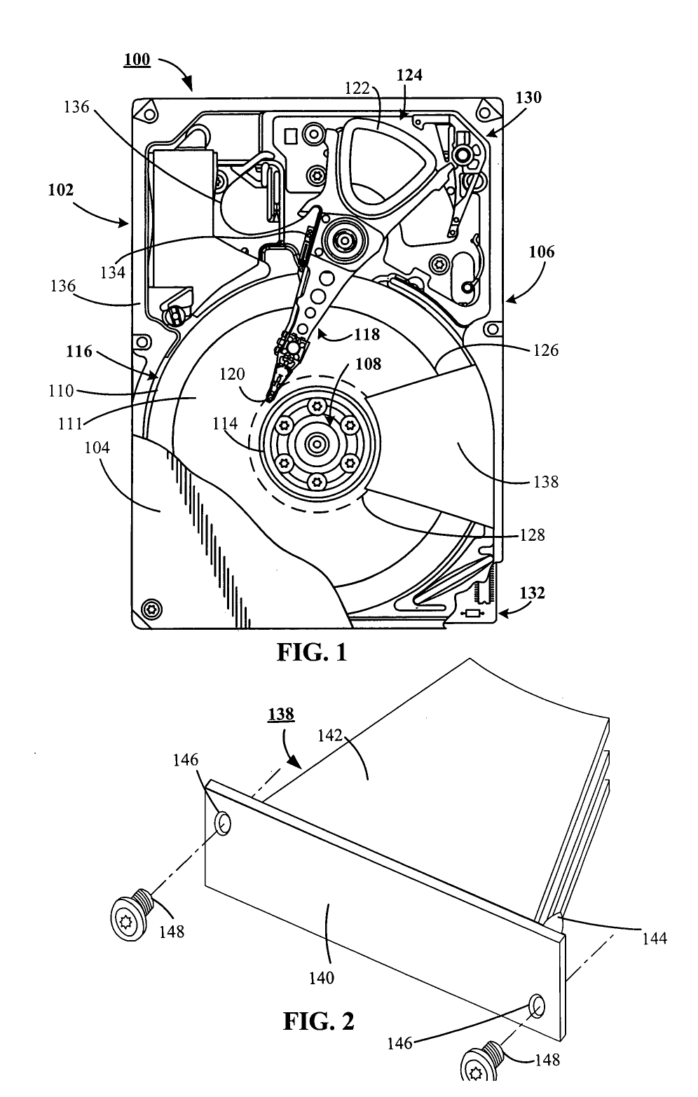

Referring now to the drawings, FIG. 1 provides a top plan view of a data storage device (DSD) 100. The DSD 100 includes a base deck 102 cooperating with a top cover 104 (shown in partial cutaway) to form a sealed housing for a mechanical portion of the DSD 100, referred to as a head-disc assembly (HDA) 106.

A spindle motor assembly 108 (also referred to as a motor 108) rotates a number of data storage discs 110 with a magnetic recording surface (surfaces) 112 at a substantially constant operational speed. Each disc 110 includes at least one magnetic recording surface 112. The discs 110 are secured to the motor 108 by a disc clamp 114 to form a disc stack assembly 116.

An actuator 118 supports and rotates a number of read/write heads (heads) 119 adjacent the magnetic recording surfaces 112 when current is applied to a coil 120 of a voice coil motor (VCM) 122. The heads 119 are secured to a suspension 123, which is attached to an actuator arm 124 of the actuator 118. The suspension 123 assures a consistent, predetermined spring force is applied to the head 119 for proper control of the head 119 relative to the disc 110.

During operation of the DSD 100, the actuator 118 moves the heads 119 to data tracks 126 on the surfaces 112 to write data to, and read data from the discs 110. When the DSD 100 is deactivated, the actuator 118 moves the heads 119 to a predetermined position. For example, the actuator 118 may position the heads 119 adjacent a home position 128, and utilize a toggle latch 130 to constrain motion of the actuator 118. However, alternative means for restraining the actuator 118 may be employed, for example, a ramp load/unload mechanism (not shown) may be incorporated to constrain movement of the actuator 118 during periods of inactivity of the DSD 100.

During operation of the DSD 100, a combination air plate and diverter 138 is located upstream of the heads 119 to mitigate turbulent air flow across the actuator 118 and the disc stack assembly 116, i.e., the active mechanical components of the DSD 100. Turbulent air flow causes a vibrational response from the active mechanical components of the DSD 100, which promotes off-track disturbances.

In a preferred embodiment, the combination air plate and diverter 138 reduces the volume of space present between the discs in which a fluid used to support flight of the heads 119 during active operations of the DSD 100 may occupy. The reduction in the available space between the disc 110 and combination air plate and diverter 138 facilitates a reduction in a ratio between the turbulent air flow portion of the fluid passing between the disc 110 and combination air plate and diverter 138, and the laminar air flow portion of the fluid passing between the disc 110 and the combination air plate and diverter 138.

Reducing the ratio between the turbulent and laminar portions of the fluid stream passing between the disc 110 and combination air plate and diverter 138 provides a more constant and consistent application of fluid force against the active mechanical components, which can be readily compensated for by control electronics of a printed circuit board assembly 132 mounted to the HDA 106.

Because the fluid force encountered by the active mechanical components of the of the DSD 100 is a more constant and consistent force, a reduction in the level of disturbances encountered by the active mechanical components of the DSD 100 is manifested by a reduction in vibrations experienced by the active mechanical components of the DSD 100 during operations of the DSD 100. A reduction in vibrations experienced by the active mechanical components during active operations of the DSD 100 aids in a reduction of off-track errors encountered by the DSD 100 during active operations of the DSD 100, and facilitates expansions in aerial density of the DSD 100.

FIG. 2 shows a preferred embodiment of the combination air plate and diverter 138, which includes a retention member 140 supporting an air plate/diverter member 142 (three shown). The retention member 140 provides a pair of alignment pins 144 (one shown) for use in aligning the combination air plate and diverter 138 adjacent the base deck 102 (of FIG. 1). Also provided by the retention member 140 is a pair of mounting apertures 146. Each mounting aperture accommodates passage of an attachment means 148 for engagement with the base deck 102 (of FIG. 1).

The combination air plate and diverter 138 is installed subsequent to the discs 110 and actuator 118. Because the combination air plate and diverter 138 is installed subsequent to the discs 110 and actuator 118, the combination air plate and diverter 138 is easily removed for repair or replacement of the disc stack assembly 116, the actuator 118, or the combination air plate and diverter 138, thereby providing a cost advantage during the manufacturing process.

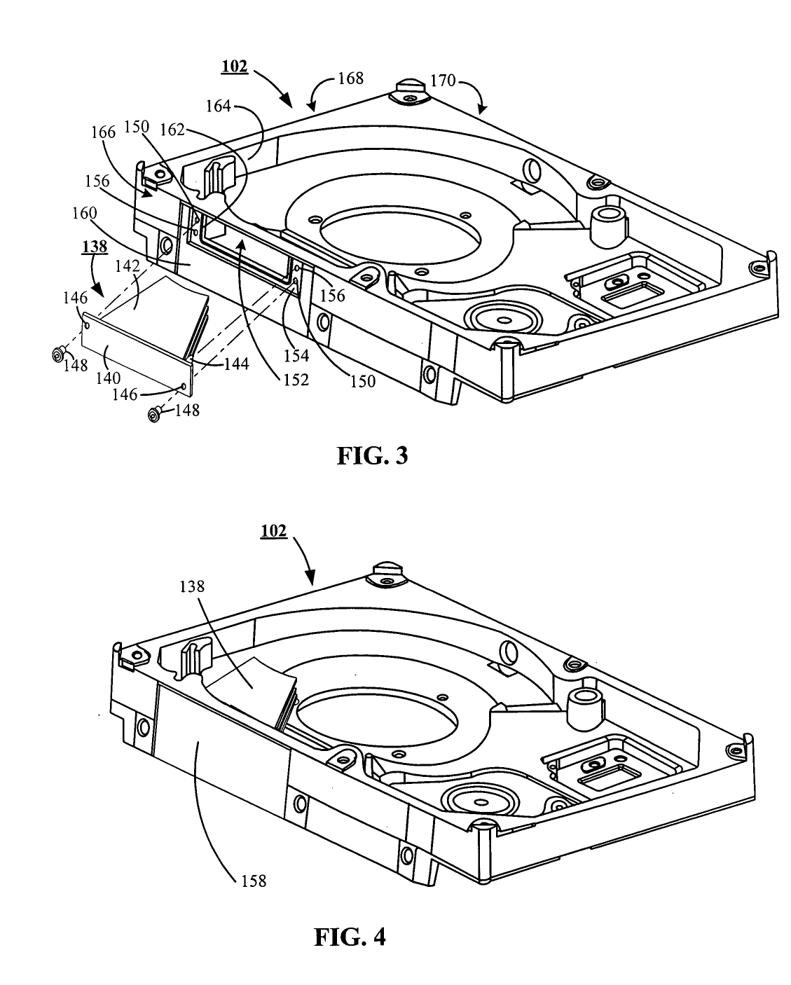

In a preferred embodiment shown by FIG. 3, each attachment means 148 passes through one of the mounting apertures 146, and engages a corresponding attachment receptacle 150 of the base deck 102. The base deck 102 further provides a diverter mounting aperture 152, through which the combination air plate and diverter 138 is mounted to align each air plate/diverter member 142 adjacent a corresponding disc 110 (of FIG. 1).

Diverter mounting surfaces 154 of the base deck 102 confining the diverter mounting aperture 152 are preferably machined, and the alignment pins 144 each engage an alignment receptacle 156 prior to installation of each attachment means 148. A press fit tolerance between each alignment pin 144 and its corresponding alignment receptacle 156 has been found useful in attaining and maintaining a predetermined separation between each air plate/diverter member and its corresponding disc 110. In a preferred embodiment, the combination air plate and diverter 138 is a molded polymer preferably formed from a thermo-set plastic, but alternatively may be an extruded polymer, a cast, or extruded metallic component, a ceramic compound, or, an insert molded combination thereof.

FIG. 4 shows a preferred embodiment of the combination air plate and diverter 138 in a final mounting position relative to the base deck 102. Preferably, a sealing tape 158 is adhered to the base deck 102, to preclude migration into the internal environment of the HDA 106 (of FIG. 1) from air external to the HDA 106. For purposes of clarity in showing the relationship between the combination air plate and diverter 138 and the base deck 102, the disc stack assembly 116 (of FIG. 1) has been removed from the illustration. However, it is noted that the combination air plate and diverter 138 is a side load device and is preferentially installed after the disc stack assembly 116 has been secured to the base deck 102, particularly for disc stack assemblies 116 with a plurality of discs 110 (of FIG. 1).

In other words, with the disc stack assembly 116 secured to the base deck 102, the air plate/diverter members 142, shown by FIG. 3, are simultaneously slipped above, between adjacent, or below each corresponding disc 110 of the disc stack assembly 116 during the assembly process of the HDA 106 (of FIG. 1). By side loading the combination air plate and diverter 138 into mating contact with the base deck 102, after the disc stack assembly 116 is in place, the advantages of the unitary design of the combination air plate and diverter 138 are realized.

It is further noted that during the assembly process of the HDA 106, the actuator 118 (of FIG. 1) may be installed either prior to, or subsequent to the installation of the combination air plate and diverter 138, and as with the combination air plate and diverter 138, the actuator 118 is preferably secured to the base deck 102 after the disc stack assembly 116 has been installed, or assembled and secured within the base deck 102.

Returning to FIG. 3, a recess surface 160 is provided by the base deck 102, which is preferably a cast surface having a substantially smooth cast surface to enhance the sealing capabilities of the sealing tape 158 (of FIG. 4).

As shown by FIG. 3, in an alternate preferred embodiment, a diverter seal gasket 162 is provided to attain the desired barrier between the environment external to the HDA 106 (of FIG. 1), and the environment internal to the HDA 106. When practicing the alternate preferred embodiment, each attachment receptacle 150 and each alignment receptacle 156 preferably maintains the integrity of the environment internal to the HDA 106 by not breaching the interior surface 164 of the base deck 102.

Because of its unitary design, a benefit of the present invention is that it makes the installation process of the plurality of plate/diverter member 142 very simple and much less time consuming, as compared to alternate methods, such as installing alternate, individual plate or diverter members. Additionally, there will also be less stack tolerance as compared to the alternate individual plate or diverter members design, since the combination air plate and diverter 138 is a unitary component, rather than an assembly of individual component parts.

Another advantage of the present invention is that there could be up to three combination air plate and diverters 138 in a single DSD 100 (of FIG. 1), as well as a selectable number of air plate/diverter members 142 for each combination air plate and diverter 138 utilized.

FIG. 3 further shows a preferred embodiment of the combination air plate and diverter 138 installed on a first side 166 of the base deck 102. However, the diverter mounting aperture 152 (along with the accompanying mounting features associated with the diverter mounting aperture 152) may be formed on either the first side 166, a second side 168, or a third side 170, or any combination thereof appropriate for the level, and type of vibration due to airflow generated by the rotation of the disc 10 sought to be relieved. The air-plate effect of the combination air plate and diverter 138 aids in reducing the level of vibration of the discs 110, and the diverter effect reduces the airflow excitation on arms, suspensions, and sliders of the actuator 118 (of FIG. 1).

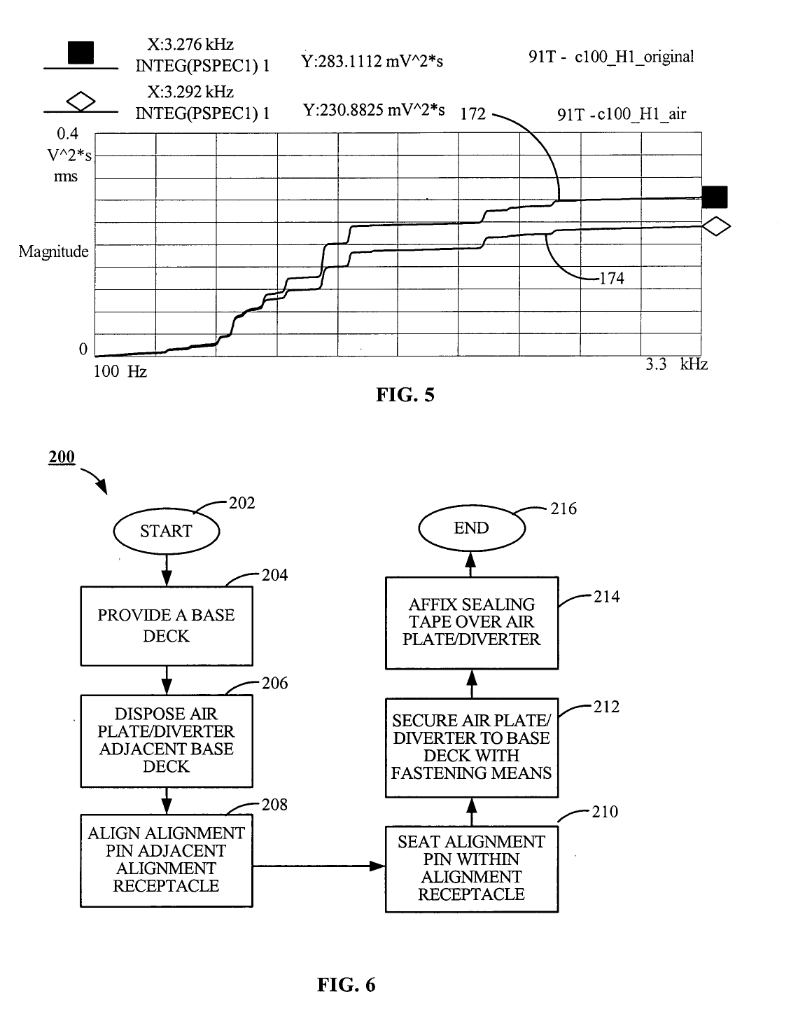

As shown by FIG. 5, a DSD magnitude level position error signal (PES), of a spectrum test shows that the present invention reduces the vibrational effects induced by the airflow generated by the rotation of the disc 110 (of FIG. 1), for both the discs 110 and the actuator 118 (of FIG. 1). A DSD 100 (of FIG. 1), without the combination air plate and diverter 138 (of FIG. 2) installed, displays a PES response shown by response magnitude line 172. The inclusion of the combination air plate and diverter 138 on the DSD 100 results in a substantially improved PES response magnitude line 174. The substantially improved PES response magnitude line 174 is a direct result of the reduction in the ratio between the turbulent and laminar portions of the fluid stream passing between the disc 110 (of FIG. 1) and combination air plate and diverter 138 (of FIG. 1), which reduces the turbulence experienced by the active mechanical components of the DSD 100. The reduction in the level of disturbances encountered by the active mechanical components of the DSD 100 is manifested by a reduction in off track excursions reported by the heads 120 (of FIG. 1) through the PES (position error signal), thus the substantial improvement shown by the PES response magnitude line 174.

FIG. 6 shows an assembly process 200, for assembling a combination air plate and diverter (such as 138) to a base deck (such as 102) with an attached disc stack assembly (such as 116) commencing at start process step 202, and continues at process step 204. At process step 204, the base deck with attached disc stack assembly is provided for receipt of the combination air plate and diverter, which is disposed on a side, or combination of sides (such as 166, 168, 170) of the base deck at process step 206. At process step 208, an alignment pin (such as 144) is aligned to an alignment receptacle (such as 156). At process step 210, the combination air plate and diverter is pressed adjacent the base deck by seating the alignment pin within the alignment receptacle.

At process step 212, an attachment means (such as 148) captures and secures the combination air plate and diverter in mating contact with the base deck. At process step 214, a seal tape (such as 158) is positioned over the combination air plate and diverter, and the side of the base deck to seal an internal environment of a HDA (such as 106) from intrusion by an environment external to the HDA, and the assembly process concludes at end process step 216.

Accordingly, embodiments of the present invention are generally directed to a method (such as 200, as described hereinabove) and combination for mitigating turbulent air flow across an actuator (such as 118), and a disc stack (such as 116) of a data storage device (such as 100). The combination preferably includes, a base deck (such as 102), which has a diverter mounting aperture (such as 152), an attachment receptacle (such as 150), and an alignment receptacle (such as 156) each confined by a diverter mounting surface (such as 154).

The combination further preferably includes a combination air plate and diverter (such as 138). The combination air plate and diverter includes a retention member (such as 140) supporting an air plate/diverter member (such as 142), which protrudes through the diverter mounting aperture of the base deck. The retention member further preferentially supports an alignment pin (such as 144) that engages the alignment receptacle, and a mounting aperture (such as 146) that receives an attachment means (such as 148). The attachment means secures the retention member adjacent the diverter mounting surface, by engaging the attachment receptacle.

The method preferentially includes; disposing the retention member adjacent the diverter mounting surface, press fitting the alignment pin supported by the retention member into the alignment receptacle of the base deck, securing the combination air plate and diverter to the base deck with the attachment means, and sealing an internal environment of the base deck from intrusion by an environment external to the base deck with a seal (such as 158, 162).

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the appended claims.

1. An apparatus comprising:
a retention member configured to extend through a first aperture in a wall and having an internal surface and an external surface;
an air plate/diverter member extending from the internal surface of the retention member; and
an alignment pin supported by the retention member and which extends from the internal surface of the retention member to fixidly align the retention member with the wall.

2. The apparatus of claim 1 in combination with a base deck having a side wall in mating contact with the internal surface of the retention member, wherein the internal surface of the retention member is disposed adjacent an external surface of the side wall, and the air plate/diverter member protruding through the side wall.

3. The apparatus of claim 2 further comprises an alignment receptacle provided by the base deck engaging the alignment pin to align the air plate/diverter member relative to the side wall.

4. The apparatus of claim 3 further comprising:
a mounting aperture provided by the retention member;
an attachment means engaging the mounting aperture; and
an attachment receptacle provided by the base deck, wherein the attachment means communicates with the attachment receptacle to secure the internal surface of the retention member adjacent the external surface of the side wall of the base deck.

5. The apparatus of claim 4 further comprising a seal communicating with the retention member while communicating with the base deck to preclude migration of an environment adjacent the external surface of the base deck to an environment adjacent the internal surface of the retention member.

6. The apparatus of claim 5, in which the seal is a tape seal pressingly engaging both the external surface of the base deck and the external surface of the retention member.

7. The apparatus of claim 5, in which the seal is a gasket disposed adjacent both the external surface of the base deck and the internal surface of the retention member.

8. The apparatus of claim 3, in which the base deck provides a diverter mounting aperture adjacent the alignment receptacle, wherein the diverter mounting aperture promotes the protrusion of the air plate/diverter member through the side wall.

9. The apparatus of claim 8 further comprising:
a mounting aperture provided by the retention member;
an attachment means engaging the mounting aperture; and
an attachment receptacle provided by the base deck, wherein the attachment means communicates with the attachment receptacle to secure the internal surface of the retention member adjacent the external surface of the side wall of the base deck.

10. The apparatus of claim 9 further comprising a seal communicating with the retention member while communicating with the base deck to preclude migration of an environment adjacent the external surface of the base deck to an environment adjacent the internal surface of the retention member.

11. The apparatus of claim 10, in which the seal is a tape seal pressingly engaging both the external surface of the base deck and the external surface of the retention member.

12. The apparatus of claim 10, in which the seal is a gasket adjacent the attachment receptacle and disposed adjacent both the external surface of the base deck and the internal surface of the retention member.

13. The apparatus of claim 11, in which the external surface of the base deck provides a recess surface, wherein the seal tape pressingly engages the recess surface.

14. The apparatus of claim 2 further comprises a spindle motor assembly supporting a disc, the spindle motor assembly attached to the base deck.

15. The apparatus of claim 14, in which the side wall comprises a plurality of sides, wherein each side of the plurality of sides is adjacent the disc.

16. The apparatus of claim 15, in which the retention member having the air plate/diverter member and the alignment pin extending from the internal surface of the retention member, is a plurality of retention members each having an air plate/diverter member and an alignment pin extending from an internal surface of each retention member, wherein each of the plurality of sides support one of the plurality of retention members having the air plate/diverter member and the alignment pin extending from the internal surface of the retention member.

17. A method for assembling a combination air plate and diverter to a base deck supporting a disc stack assembly having an attached disc, and having an actuator adjacent the disc and mounted to the base deck by steps comprising:
disposing the combination air plate and diverter through a side of the base deck and adjacent the disc;
sliding an alignment pin of the combination air plate and diverter into mating contact with an alignment receptacle of the base deck; and
sealing an internal environment of the base deck from intrusion by an environment external to the base deck.

18. A combination comprising:
a base deck having a diverter mounting surface; and
a combination air plate and diverter secured adjacent the diverter mounting surface by steps for assembling a combination air plate and diverter to a base deck.

19. The combination of claim 18, in which the combination air plate and diverter comprises:
a retention member having an internal surface and an external surface;
an air plate/diverter member extending from the internal surface of the retention member in a first direction; and
an alignment pin supported by the retention member extends from the internal surface of the retention member in a second direction substantially parallel to the first direction that the air plate/diverter member extends.

20. The combination of claim 19, in which the diverter mounting surface provides an alignment receptacle, and in which the steps for assembling a combination air plate and diverter to a base deck are steps comprising:
disposing the combination air plate and diverter through a side of the base deck and adjacent the disc;
sliding an alignment pin of the combination air plate and diverter into mating contact with an alignment receptacle of the base deck; and
securing the combination air plate and diverter to the base deck with an attachment means; and
sealing an internal environment of the base deck from intrusion by an environment external to the base deck.
